(19) United States
(12) Patent Application Publication
(10) Pub. No.: US 2007/0245133 A1
(43) Pub. Date: Oct. 18, 2007

(54) Method and Device for Switching Between at Least Two Operating Modes of a Processor Unit

(76) Inventors: Reinhard Weiberle, Vaihingen/Enz (DE); Thomas Kottke, Ehningen (DE); Andreas Steininger, Wien (AT)

Correspondence Address: KENYON & KENYON LLP, ONE BROADWAY, NEW YORK, NY, 10004, US

(21) Appl. No.: 10/577,009

(22) PCT Filed: Aug. 20, 2004
(86) PCT No.: PCT/DE04/01859

§ 371 Date: Feb. 15, 2007

(30) Foreign Application Priority Data
Oct. 24, 2003 (DE) 10349581.9

(51) Int. Cl. G06F 9/318

(52) U.S. Cl. 712/229

(57) ABSTRACT

A method and a device are described for switching between at least two operating modes of a processor unit including at least two execution units for running programs, at least one identifier being assigned to at least the programs which differentiates between the at least two operating modes, and switching between the operating modes is performed as a function of the identifier such that the processor unit runs the programs according to the assigned operating mode.

### FIELD OF THE INVENTION

The present invention is directed to a method and a device for switching between at least two operating modes of a processor unit as well as a corresponding processor unit including at least two execution units for running programs.

### BACKGROUND INFORMATION

Such processor units including at least two integrated execution units are also known as dual-core or multi-core architectures. According to the present related art, such dual-core or multi-core architectures are primarily used for two reasons:

In the first instance, they can be used to achieve a performance increase by viewing and treating the two execution units or cores as two arithmetic-logic units on one semiconductor device. In this configuration, the two execution units or cores process different programs or tasks. This makes it possible to achieve a performance increase, for which reason this configuration is described as a performance mode.

In addition to the use as superscalar processors, the second reason for implementing a dual-core or multi-core architecture is to increase safety by having both execution units redundantly run the same program. The results of the two execution units are compared, making it possible to detect an error while comparing for agreement. This configuration is described below as the safety mode.

In general, the two aforementioned configurations are contained exclusively in the dual- or multi-core architecture, i.e., the computer having the at least two execution units is basically operated in only one mode: either the performance mode or the safety mode.

### SUMMARY OF THE INVENTION

The object of the present invention is to make combined operation of such a dual- or multi-core processor unit possible with respect to at least two operating modes and in so doing achieve an optimal switching strategy between at least two operating modes, i.e., in particular between a safety mode and a performance mode.

A redundant execution of the programs or tasks, in other words also of task programs, program segments, i.e., code blocks, or even individual instructions is desirable for reasons of safety; however, cost factors also make it undesirable to maintain completely redundant hardware for executing non-safety-critical functions. According to the present invention, these conflicting objectives are resolved through optimized switching between at least two operating modes in one processor unit. The present invention is thus directed to a method and a device for switching between at least two operating modes of a processor unit including at least two execution units and a corresponding processor unit. The processor units may have complete cores, i.e., they may be complete CPUs, or however, in a preferred embodiment, only the arithmetic-logic unit is duplicated. If only the arithmetic-logic unit (ALU) is duplicated and the other components of the CPU are safeguarded by other error detection mechanisms, the additional advantage is that the described circuit requires less chip area than a complete dual-core architecture. Nonetheless, the method according to the present invention makes it equally possible to achieve adequate error coverage for a duplicate CPU or a duplicate ALU in safety mode and a significant increase in performance in the performance mode for non-safety-relevant calculations. The present invention is thus directed to a method and a device for switching between at least two operating modes of a processor unit including at least two execution units for running programs, at least one identifier being advantageously assigned to the programs, the identifier making it possible to differentiate between the at least two operating modes, i.e., the safety mode and the performance mode in particular, and switching between the operating modes being performed as a function of the identifier such that the processor unit runs the programs according to the assigned operating mode.

The term programs also includes program segments, i.e., code blocks, which range completely or partially across a plurality of programs across task programs that are contained in the individual programs or are formed by the programs all the way to individual program instructions, an identifier being assigned to each of them.

Such an identifier assignment may be used to switch between the individual operating modes on a functional level, i.e., in particular for controlling operating sequences in a vehicle. Programs or corresponding task programs, program segments, or program instructions that are associated with an operating system of the processor unit or constitute this operating system may also be advantageously assigned to the corresponding operating mode using such identifiers.

When the programs are run, the conditions or results obtained are advantageously compared for agreement, errors being detected if there is a discrepancy.

It is advantageous in particular that the programs are run synchronously.

Advantageously, the identifier is in the form of at least one bit, such an identifier advantageously being generated by a program instruction, in particular by an instruction provided in the instruction set of the processor unit such as, for example, a write instruction.

This identifier may be assigned to the corresponding program, program segment, execution program or program instruction or however, it may be written in a special memory area that is provided.

As a function of the identifier, it is thus possible to switch optimally between two operating modes, in particular the performance mode and the safety mode, in a dual-core architecture or an architecture having only a duplicate arithmetic-logic unit, i.e., a duplicate ALU.

### BRIEF DESCRIPTION OF THE DRAWINGS

FIG. 1 and FIG. 2 each show a processor unit including a duplicate arithmetic-logic unit in which the switching according to the present invention may be performed.

FIG. 3 shows the switch from the safety mode into the performance mode.

FIG. 4 shows the switch from the performance mode into the safety mode.

FIG. 5 shows the assignment of the identifiers to the programs, program segments, task programs, or instructions.

### DETAILED DESCRIPTION

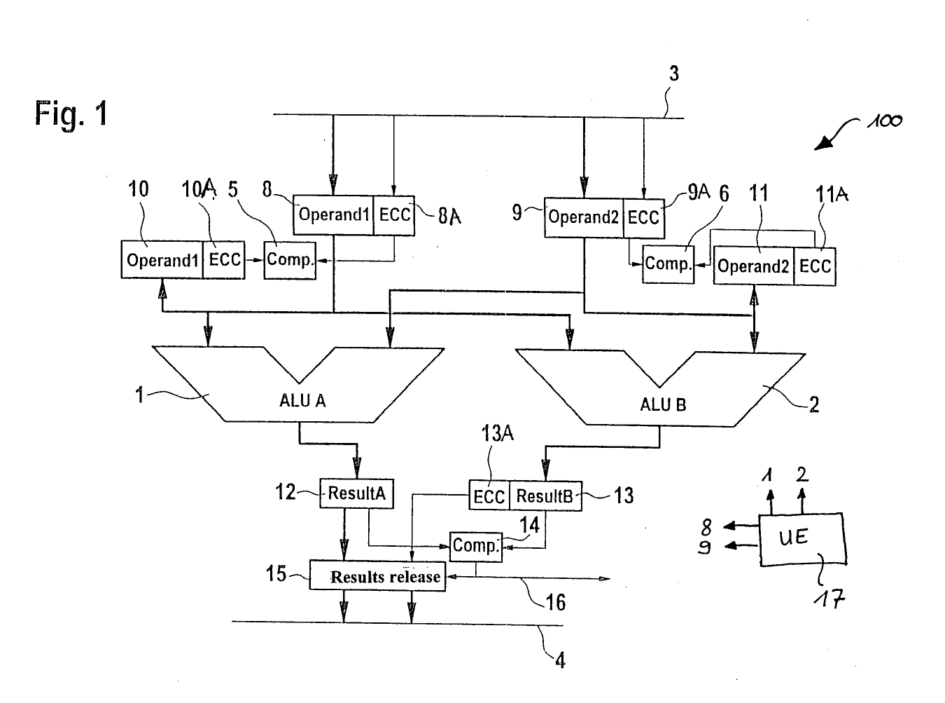

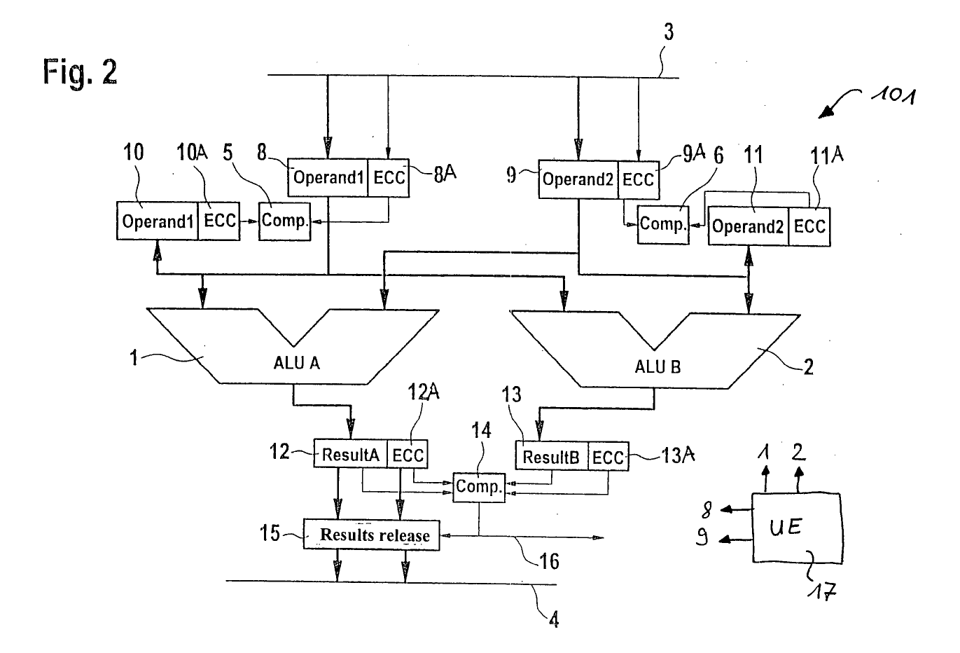

In FIGS. 1 and 2 of the drawing, unless specified otherwise, identical elements or elements having an identical function have been provided with identical reference numerals. For the sake of clarity, the program-controlled unit according to the present invention and its components, such as the microcontroller core (CPU), memory units, peripheral units, etc., are not shown directly in FIGS. 1 and 2. However, the two arithmetic-logic units ALU A and ALU B may also correspond to complete cores, i.e. CPUs, within the scope of the present invention, so that the present invention may also be used for complete dual-core architectures. However, preferably only the arithmetic-logic unit is duplicated and the other components of the CPU are safeguarded by other error detection mechanisms.

In FIGS. 1 and 2, reference numerals 1 and 2 denote arithmetic-logic units (ALU) as execution units. A particular ALU unit 1, 2 has two inputs and one output. In a test operation, the operands provided for the execution may be coupled directly from bus 3 into the inputs of ALU units 1, 2 or they may be stored in advance in an operand register 8, 9 provided specifically for that purpose. These operand registers 8, 9 are directly coupled to data bus 3. The two ALU units 1, 2 are thus supplied from the same operand registers 8, 9. In addition, it may be provided that the particular operands are already supplied with an ECC coding via the bus, the ECC coding being stored in register areas 8a, 9a. This means that the data may be safeguarded using an ECC (error correction code) at all locations in FIGS. 1 and 2 in which ECC is indicated. Such methods for error recognition are manifold, the basic requirement being the use of an error detection code or an error correction code, i.e., a signature, as a safeguard. In the simplest case, this signature may be made up of only one signature bit, for example, a parity bit. The safeguard may also be implemented by more complex ED (error detection) codes such as a Berger code or a Bose-Lin code, etc., or even by a more complex ECC code such as, for example, a Hamming code, etc., in order to make reliable error detection possible through a corresponding bit number. However, it may also be used as a code generator, for example, a generator table (hard wired or in software), in order to assign a desired code pattern of any length to specific input patterns of the bits in connection with the address. This makes it possible to ensure data integrity, in particular through the correction function. However, in the safety-critical mode, i.e., in safety mode SM, the safety-critical programs are run redundantly in both execution units, i.e., both ALUs 1 and 2 in this case, errors being detected in them according to the present invention by comparing for agreement.

The non-safety-relevant or non-safety-critical programs or tasks, or rather program segments or code blocks or instructions may be calculated distributed over both execution units to improve performance, the throughput and thus the performance being increased accordingly. This takes place in performance mode LM.

When the particular operands are coupled into ALU units 1, 2, particular importance must be attached to correct data input. If, e.g., the same faulty operands are coupled into the two ALU units 1, 2, it is not possible to detect an error at the output of ALU units 1, 2. It must therefore be ensured that at least one of ALU units 1 or 2 receives a correct data input value or both ALU units 1, 2 receive different but incorrect data input values. This is ensured by the fact that a checksum, i.e., an ECC code, is, as mentioned above, formed from at least one input value of an ALU unit 1, 2. In a specifically provided comparison unit 5, 6, ECC coding 10a, 11a from these additional data registers 10, 11 is compared with ECC coding 8a, 9a from original source register 8, 9. As an option, the input data from registers 10, 11 may also be compared with that from source registers 8, 9. If a difference arises in the ECC coding, i.e., in the operands, this is interpreted as an error and an error signal is output, displayed if appropriate and corrected if appropriate. This comparison is advantageously made while the operands are processed in ALU units 1, 2 so that this input-side error detection and error correction proceeds with almost no loss of performance. If one of comparison units 5, 6 detects an error, the calculation may be repeated within the next cycle. A shaded register may be used to protect the operands of the last calculation constantly so that they are again rapidly available in the event of an error. The provision of such a shaded register may, however, be omitted if the particular operand registers 10, 11 are not written to again until an enable signal based on the absence of an error is received. In the case of an error, comparison units 5, 6 deliver an error signal, as a result of which it is no longer possible to write to operand registers 10, 11 again.

On the output side, each of ALU units 1, 2 generates a result. The result data provided by ALU units 1, 2 or their EEC coding is stored in results registers 12, 13, 12a, 13a. This result data and/or its coding are compared with one another in comparison unit 14. If no error is present, an enable signal 16 is generated. This enable signal 16 is coupled to enable device 15, which is prompted to write the result data to a bus 4. It is then possible to reprocess this result data via bus 4.

Furthermore, enable signal 16 may be used to clear registers 8 through 11 again so that the next operands may be read out of bus 3 and processed in ALU units 1, 2.

The system in FIG. 1 is not used to check the result. Only the result data is compared with one another here in comparison unit 14. It is only possible to check the ECC coding of the result data using the system in FIG. 2, both the result data and their ECC coding being compared with one another in comparison unit 14.

All transient errors, permanent errors, and even runtime errors are detected using the error detection systems in FIGS. 1 and 2. Runtime errors within an ALU unit 1, 2 are detected if the result does not reach or reaches comparison unit 12 too late and accordingly a comparison is made with a partial result. The particular error location and error point in time may be precisely localized by safeguarding operand registers 8, 9, 10, 11 using an error detection code and an error correction code and by comparing the end results. This makes it possible to respond very quickly to a transient fault.

The following possibilities for error localization are possible:

If a comparison of the result data in comparison unit 14 shows a difference, it is possible to infer the presence of an error within ALU units 1, 2.

If a comparison of the ECC coding in one of comparison units 5, 6 shows a difference, a faulty signal from bus 3 or upstream components may be inferred.

If a comparison of the ECC coding in comparison unit 14 shows a difference, a faulty coding of the result may be inferred.

A switching device UE 17 is used for switching between the aforementioned safety mode in which a redundant run and check takes place and the performance mode in which an increase in performance is achieved through a separate program run. This switching device 17 switches elements 8, 9 and 1, 2 in such a way that in one case, i.e., in safety mode SM, a redundant program run takes place, a synchronous program run in particular, and in the second operating mode, performance mode LM, it is possible to run different programs concurrently. To this end, switches or switching means may be provided that may be located in elements 8, 9 and 1, 2, respectively, or in switching device 17, or in addition they may be contained in the circuit separate from elements 8, 9, 1, 2, or 17.

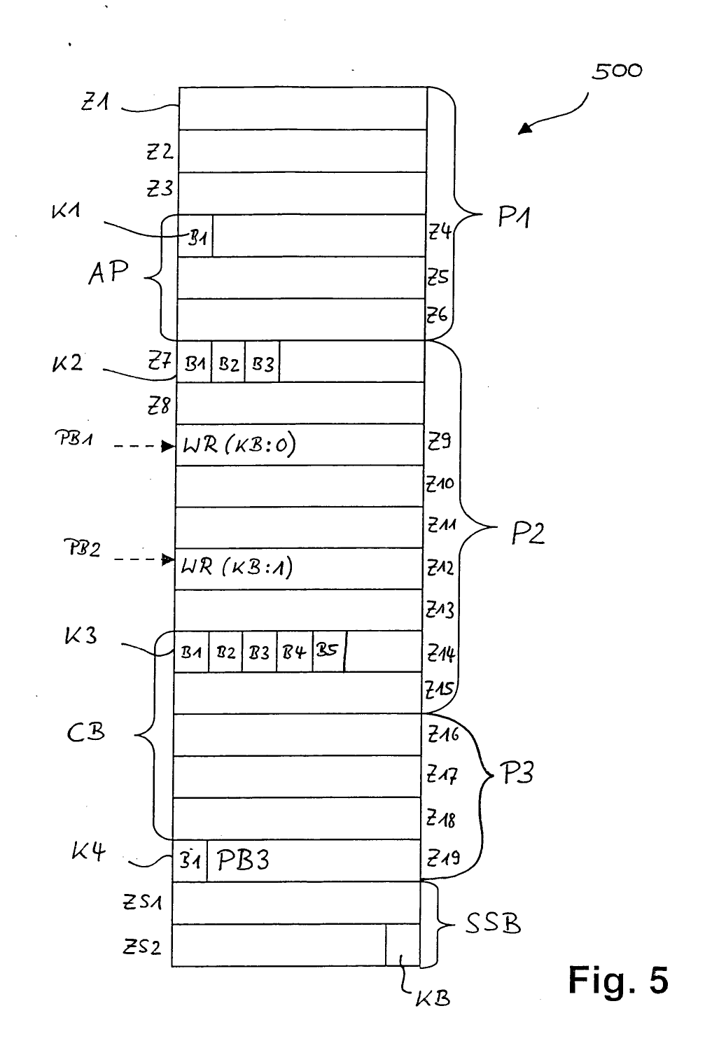

For the switching, the programs or task programs or program segments, i.e., code blocks or even the instructions, are identified by an identifier that makes it possible to detect if they are safety-relevant, i.e., they must be run in safety mode SM, or may be made accessible to performance mode LM. This may be accomplished by a bit in the instruction or a special instruction may identify the subsequent sequence. This is described in greater detail with reference to the different identification possibilities in FIG. 5.

The programs may include application functions, for example, for controlling operating sequences in a vehicle in particular, or the switch is made with respect to programs in which the identification is made on the operating system level, e.g., an assignment of entire operating system tasks.

In a decoding, switching device 17 is able to detect if the following calculation is safety-relevant, i.e., it should or should not be performed in the safety mode. If it should, the data is transferred to the two execution units 1 and 2. If not, i.e., work is continued in the performance mode, an execution unit receives the data, and the next instruction, provided it is also not safety-relevant, is transferred simultaneously to the second execution unit, making it possible to run the programs concurrently with higher throughput.

In the first case, for example, the calculation of the result during synchronous processing is of equal duration on both units. Thus, the results are available simultaneously during synchronous processing in the safety mode. This data is again provided with a coding at the output corresponding to 12 and 13 and the data and/or the coding of this data are, as described in FIGS. 1 and 2, compared at Result a and Result b. If they agree, the data is released; otherwise one of the aforementioned error responses takes place. In the second case, i.e., in performance mode LM, if the data is processed concurrently, comparator 14 at the output of the two arithmetic-logic units is not activated and Result a and Result b are again written back in succession into the register bank and may also be output in succession, as is also the case in a superscalar processor.

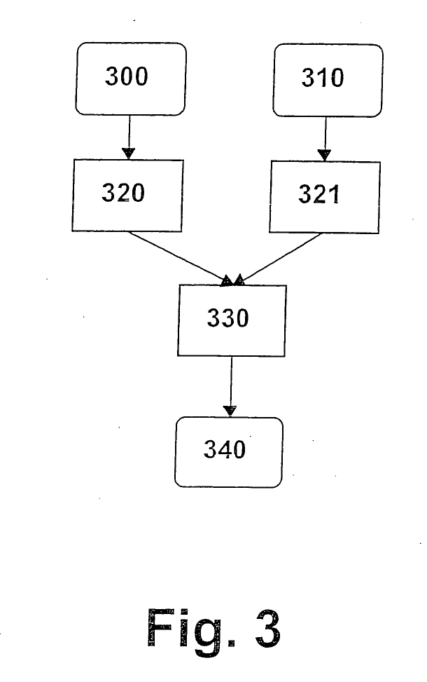

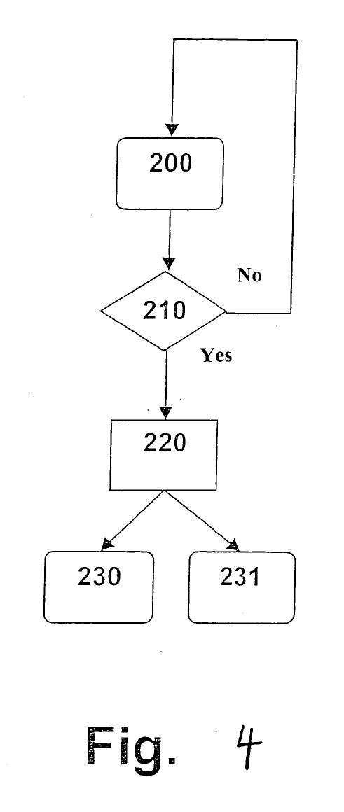

This switching process according to the present invention is elucidated once more in FIGS. 3 and 4. In this connection, FIG. 3 shows the switch from the safety mode into the performance mode and FIG. 4 shows the switch from the performance mode into the safety mode.

An identifier and a corresponding switch are necessary to pass from the first operating mode, i.e., safety mode SM, into the second operating mode, i.e., performance mode LM in this case. This is depicted once more in FIG. 3. In block 300, execution unit 1 is in the second operating mode, the performance mode. Similarly, second execution unit 2 is also in performance mode in block 310. Likewise, elements 8 and 9 are controlled or switched by switching device 17 which is designed, for example, as a decoder module, or contains one. Corresponding to the program sequence of the particular execution block 1 or 2, at least one identifier is determined in block 320 and block 321, respectively, the identifier causing both execution units to be switched into the first operating mode, safety mode SM, in block 330. As a result, both branches again run across blocks 8 and 9 and execution units 1 and 2 redundantly and in particular synchronously with respect to the programs identified as safety-relevant by the identifier so that safety mode SM is again present. It is sufficient for one such identifier to be present for switching in one program run in the performance mode, i.e., in a branch, in order to guide both execution units into the safety mode. It may possibly still be necessary to process the already started program code of the other execution unit in order to allow both to continue operating in the safety mode. It may also be provided to switch immediately into the safety mode and further process the started program starting from the point of interruption in a subsequent performance mode.

In order to reach the second operating mode, the performance mode in this case, from the first operating mode, an identifier according to FIG. 4 is also assigned. In block 200, both execution units 1 and 2 and accordingly the branches including blocks 8 and 9, i.e., of the operand connection, are in safety mode, the first operating mode. In query block 210, it is checked if a switch identifier is present or if an identifier that is present makes it possible to switch into the performance mode. If not, i.e., no identifier is present or the identifier continues to indicate the safety mode, a return is made to block 200 and the programs continue to be run in safety mode. If an identifier is present or it indicates the switch, the switch or change is made into the second operating mode, performance mode LM in block 220. Since the identical programs are run concurrently, i.e., redundantly, in safety mode, a switch is made in this case only if it is provided for based on the identifier for both branches in the performance mode, i.e., block 8 and ALU 1 as well as block 9 and ALU 2. If a run is fully synchronous, i.e., the program run is isochronous, this occurs in any event; if processing of the program is asynchronous, the faster execution unit must wait for the slower one and thus switching device 17 does not switch over until both identifiers are present or have been analyzed. For the results comparison or ECC and results comparison according to blocks 12, 13, and 14 as well as 12a and 13a, such synchronicity must either be forced through isochronicity or generated by waiting.

The first branch, i.e., block 8 and execution unit 1 in block 230 and the second branch including block 9 and execution unit 2 in block 231 are thus again in the performance mode, as a result of which the switch according to the present invention is completed.

Thus, corresponding to the objective, an optimized switch between two operating modes of a processor unit including two integrated execution units is depicted according to the present invention, it being possible for the identifier to be introduced or localized in a program or data line segment 500 in a variety of ways according to FIG. 5. Furthermore, the lines in FIG. 5 are considered to be lines of code, lines of code and data lines being possible in any desired combination in this case also.

As an example, programs P1 from line Z1 through line Z6, P2 from line Z7 through Z15, and P3 from line Z16 through Z19 are shown in FIG. 5. A task program is depicted as AP, for example, as a part of a program P1, it also being possible for a plurality of programs, e.g., P1 and P2, to form a task program in aggregate. A code block is depicted as CB, i.e., a program segment that includes, for example, lines of two programs, Z14 through Z18 of programs P2 and P3 in this case. Similarly, such a code block, i.e., a program segment, may be only part of a program. Furthermore, PB3 depicts a program instruction according to line Z19. Lines ZS1 and ZS2 depict a special memory area SSB, which may contain such an identifier, KB in this case, as a predetermined memory area. In addition, K1, K2, K3 and K4 as well as KB depict various identifiers that take into account the various possibilities of the method according to the present invention. With respect to the use of the identifier, there are various possibilities: safety mode SM (as well as the performance mode, of course) may be provided as a basic processing mode, i.e., as a default mode. If an identifier is present, the process is accordingly switched into the performance mode (or conversely into the safety mode). According to the present invention, it may also be provided that an identifier must be present in principle and the corresponding mode is inferred from the content of the identifier, its bit value in particular. For example, a binary value 1 (or another value, the dominant value in particular) is then assigned to safety mode SM and binary value 0 (or another value, the recessive value in particular) is assigned to performance mode LM. With respect to the consideration of dominant and recessive, the result of this is that in the event of an error or failure, the dominant value and accordingly the safety mode is normally set. According to line Z4, a binary value B1, i.e., K1/B1, is present as identifier K1, which indicates, for example, that the task program of lines Z4 through Z6 in program P1 may be processed in performance mode, although program P1, for example, must be processed in safety mode. As can be seen from identifiers K1, K2 and K3, these may be of varying length so that, for example, in the case of identifier K2 according to line Z7, 3 bits, B1 through B3, make up the identifier, so that bit B1 in K2 is used to decide for safety mode SM or performance mode LM and, for example, bits B2 and B3 indicate the number of lines to which this mode, in safety mode, for example, applies so that entire program P2 or even only a part of it is run in safety mode. Similarly, code blocks, i.e., program segments, that do not include, for example, a total task, i.e., do not depict a task program, shown here as CB, may be assigned to a mode by an identifier, such as K3 in this case. In addition to the assignment of operating modes using bit B1 at K3, it is, for example, also possible to indicate an initial line or address using bits B2 and B3 at K3 and an end line or end address using bits B4 and B5 at K3 so that a special area in a correspondingly assigned operating mode is run. Such an assignment of identifiers may be made according to K4 but also in Z19 in the case of individual instruction PB3 or even for any instruction. As has been shown, these identifiers may thus be assigned to complete programs or task programs AP or program segments CB, or even individual program instructions PB, PB3 in this case, which then triggers a corresponding switch by switching device 17. The query in block 210 or also in blocks 320 and 321 then checks for the presence of such an identifier K1 through K4 or KB, or its content. In this connection, the identifier, as shown here, may be made up of at least one bit but it may also include a plurality of bits, both as a function of the varying number of operating modes and also due to supplemental information such as the number of lines or an initial or end address.

In a special embodiment, at least one program instruction may be provided, in this case PB1, PB2 or even PB3, which first generates an identifier indicating whether the processing is to take place in the first or second operating mode. The identifier may be written in a specific memory area SSB, depicted here as KB in ZS2. This area SSB may be located in a register in a memory integrated in the CPU but also in a memory external to it. A special instruction, e.g., PB3 or even an instruction already present in the instruction set of the processor unit, may be provided as an instruction generating this identifier KB. Thus, for example, an instruction “Generate identifier” may be implemented as a special instruction, or an instruction already present in the processor instruction set, a write instruction in particular, maybe used, as depicted by PB1 and PB2 here, so that in Z9, write instruction WR writes binary value 0 to memory area KB, depicted by WR (KB: 0) and thus all subsequent lines are run in safety mode, for example, as long as the identifier is KB0. The same instruction may then be used by WR (KB: 1) in Z12 at PB2 to enter value 1 in the memory area for identifier KB, so that from this point in time, it is possible to run the subsequent lines, e.g., in performance mode. This means that simple identifier-generating instructions, in particular a simple write instruction WR may be used, for example, to generate a corresponding switch identifier KB in a special memory area that is queried regularly.

A plurality of possibilities according to the present invention for implementing a switch of operating modes based on an identifier in a processor unit including two execution units have thus been described. The aforementioned advantages of the present invention are thus achievable.

1.-18. (canceled)

19. A method for switching between at least two operating modes of a processor unit that includes at least two execution units for running programs, comprising:
assigning at least one identifier to at least the programs, the identifier allowing a differentiation between the at least two operating modes;
switching between the operating modes as a function of the identifier such that the processor unit runs the programs according to the assigned operating mode.

20. The method as recited in claim 19, wherein the programs contain task programs or constitute them, and the identifier is assigned to the corresponding individual task programs.

21. The method as recited in claim 19, wherein the programs are made up of individual program segments or contain them, and the identifier is assigned to the corresponding individual program segments.

22. The method as recited in claim 19, wherein the programs are made up of individual program instructions, and the identifier is assigned to the corresponding individual program instructions.

23. The method as recited in claim 19, wherein the programs are part of an operating system of the processor unit or constitute the operating system.

24. The method as recited in claim 19, wherein the programs are used for controlling operating sequences of a vehicle.

25. The method as recited in claim 19, wherein a first operating mode is provided which corresponds to a safety mode in which the two execution units run identical programs redundantly.

26. The method as recited in claim 25, wherein conditions or results obtained while the programs are run are compared for agreement, errors being detected if there is a discrepancy.

27. The method as recited in claim 25, wherein the programs are run synchronously.

28. The method as recited in claim 19, wherein in the second operating mode, which corresponds to a performance mode, each execution unit runs different programs.

29. The method as recited in claim 19, wherein the identifier is in the form of at least one bit.

30. The method as recited in claim 19, wherein a program instruction provided that generates an identifier indicating if the program is to be run in the first or second operating mode.

31. The method as recited in claim 19, wherein the identifier is written to a specific memory area.

32. The method as recited in claim 31, wherein the identifier is generated by an instruction provided in an instruction set of the processor unit.

33. The method as recited in claim 32, wherein the identifier is generated by a write instruction.

34. A device for switching between at least two operating modes of a processor unit that includes at least two execution units for running programs, comprising:
an arrangement for assigning at least one identifier to at least the programs, the identifier allowing a differentiation between the at least two operating modes;
an arrangement for switching between the operating modes as a function of the identifier such that the processor unit runs the programs according to the assigned operating mode.

35. The device as recited in claim 34, further comprising:
at least duplicate arithmetic-logic units provided correspondingly as at least two execution units.

36. A processor unit for running programs, comprising:
at least two execution units;
a switching arrangement via which it is possible to switch between at least two operating modes of the processor unit, wherein:
the switching arrangement assigns at least one identifier to at least the programs, the at least one identifier allowing a differentiation between the two operating modes, and the switching arrangement being designed in such a way that the switching arrangement switches between the operating modes as a function of the identifier, and the processor unit runs the programs according to the assigned operating mode.
